(19) United States
(12) Patent Application Publication
(10) Pub. No.: US 2004/0079208 A1
(43) Pub. Date: Apr. 29, 2004

(54) Ultrasonic cutting system with protective sheet

(75) Inventors: John V. Carlson, St. Michael, MN (US); Bryan M. Clem, Mound, MN (US); Larry E. Waldack, Bloomington, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Raymedica, Inc.

(21) Appl. No.: 10/280,943

(22) Filed: Oct. 25, 2002

(51) Int. Cl. B26D 7/00

(52) U.S. Cl. 83/13; 83/547

(57) ABSTRACT

The present invention relates to an ultrasonic cutting system including a protective sheet for protecting a cutting blade. The ultrasonic cutting system includes an ultrasonic cutting device, a base plate, and a protective device. The ultrasonic cutting device is configured to cut a material and includes a cutting blade. The base plate is configured to support the material during interaction with the cutting blade. The protective device includes a protective sheet routed over the base plate. During use of the ultrasonic cutting system, the material is routed over the protective sheet prior to interaction with the cutting blade, and the protective sheet is configured to decrease contact between the cutting blade and the base plate.

### BACKGROUND OF THE INVENTION

The present invention relates to an ultrasonic cutting system. More particularly, it relates to an ultrasonic cutting system that includes a protective sheet to prolong the life of a cutting blade.

A large variety of cutting systems have typically been utilized to cut sheet materials, including hand and automatically controlled cutting systems. However, both the hand cutting systems and the automatically controlled cutting systems have numerous drawbacks. Hand cutting systems normally include hand cutting by a non-automated reciprocating knife or a razor blade. Automatically controlled cutting systems typically utilize a reciprocating knife, a rotary wheel cutter, or a drop blade. More recently, ultrasonic cutting knives have be introduced for use with hand and automatically controlled cutting systems. However, the ultrasonic cutting knives have similar drawbacks as presented by the other cutting knives or cutters.

Cutting a sheet material having one or more layers with a non-automated reciprocating knife involves guiding a hand-controlled, motor-driven, reciprocating knife through the sheet material. The reciprocating motion of the knife causes the material to lift and shift, causing waves in the various layers and negatively affecting cut accuracy and precision. To minimize shifting or lifting of the sheet material during the cutting process, the operator of the knife uses his or her free hand to press down on and hold taut the sheet material near the cutting path of the reciprocating blade. Placement of the operator's hand near the cutting path. of a motor-driven blade is dangerous, a concern further amplified as the operator simultaneously is required to operate the blade and ready the fabric for cutting. Furthermore, carefully positioning the fabric to avoid waves and shifting of fabric can be a tedious process, which expands the cutting time frame. The recently introduced ultrasonic knife has been developed and used in a similar fashion as the reciprocating knife. Unfortunately, the same concerns identified above are equally prevalent with an ultrasonic cutting knife.

Hand cutting with a razor blade has similar drawbacks. Although typically used on smaller, more manageable cuts, an initially sharp razor blade dulls quickly, leading to imperfect or partial cuts. Similarly, where a multi-layered article is being cut, it is impossible to precisely control the depth of a cutting pass. Thus, one or more of the layers may only be partially cut, and a bottom-most layer may not be cut at all. Initial imperfect or partial cuts require the operator to perform additional passes or cuts over the sheet material to be cut. Furthermore, the material being cut must be held taut so the razor blade may pass through the material to produce a clean, straight cut. In order to hold the material taut, once again the operator uses a free hand to hold the material close to the area being cut by the razor blade. Obviously, this hand position presents a distinct opportunity for operator injuries.

Automatically controlled cutting systems attempt to address some of the safety concerns described above. In an automated reciprocating knife system, for example, the reciprocating knife is guided over the material to be cut by a controlled carriage assembly. However, the material still must be held taut, which remains difficult due to the inherent tendency of the reciprocating knife to lift the material during an upstroke. Difficulty in controlling the material leads to imperfect cuts.

Automated drop blade cutting systems operate by placing the material to be cut on a work surface and dropping a sharp blade to that work surface, thereby cutting the material placed between the drop blade and the work surface. Due to the high-pressure impact of the blade on the work surface, damage to the blade and the work surface inevitably results. The blade may become dull, jagged, or slightly bent, and the work surface develops a groove and/or grooves of increasing prominence with each dropping of the blade. Either a worn blade or a worn cutting surface can cause imperfect or jagged cuts in the material.

Automatically controlled rotary wheel cutting systems operate by rolling a cutting wheel across a material placed upon a hard work surface. The rotary wheel cutting system operates in a crushing and cutting fashion. The crushing action makes it difficult to keep the material in a fixed position for cutting the desired area of the material. Furthermore, since the rotary wheel cutter must contact the work surface in order to cut, blade and surface damage invariably results. Not only will the blade and surface damage lead to imperfect or jagged cuts, but a damaged work surface may misguide the rotary wheel cutter by trapping the cutter in a pre-existing groove of the work surface.

Cutting problems associated with available hand and automatically controlled cutting systems are further amplified for processing of high tenacity and woven fabrics. High tenacity fabrics are generally more difficult to cut and typically require a very sharp blade and a high-energy cutting force. Consequently, any deficiencies in the cutting system are increased. Similarly, woven fabrics are more susceptible to partial cuts, and cutting system deficiencies often lead to fraying, which may render the piece of material unsatisfactory for its intended use. One example of a high tenacity woven fabric that poses increased processing problems is a woven material made of high molecular weight polyethylene. The previously mentioned ultrasonic knives or ultrasonic cutting devices appear to be highly useful for cutting these types of materials. Unfortunately, a truly automated ultrasonic cutting system has not been identified. Further, the same cutting concerns are equally problematic for ultrasonic knives used in industrial applications. Unfortunately, proposed solutions for non-ultrasonic cutting devices, as described below, are not acceptable for ultrasonic applications.

Typical solutions to the problems associated with common, non-ultrasonic cutting systems include cutting sticks (described, for example, in U.S. Pat. No. 2,281,877 and 2,680,484), cutting boards (described, for example, in U.S. Pat. No. 3,788,179), and elastic protective strips (described, for example, in U.S. Pat. No. 5,121,664). A cutting stick can be placed(in the work surface at the area to be contacted by a blade or a cutter. Following each cut or series of cuts, the cutting stick must be rotated to provide a new area of contact between the blade and the cutting stick. This is a cumbersome process as there are finite limitations upon the number of times a cutting stick can be used without repositioning the blade. Commonly, a single cutting stick can be utilized for eight cuts, whereby the cutting stick is rotated or flipped between each of the cutting passes.

The cutting board in U.S. Pat. No. 3,788,179 operates a similar manner as the cutting stick but on a larger scale, typically in large paper cutting machines. A cutting board is mounted between the work surface and the material to be cut. Typically, a cutting board is a rectangular, substantially flat tray that moves from position to position following each cut by the blade. The changing position presents a new surface beneath the blade for each cut. However, replacement of the cutting boards can be a laborious process, and cutting boards are primarily used with automated drop blade cutting systems rather than ultrasonic cutting systems.

In U.S. Pat. No. 5,121,664, elastic strips are inserted into a groove located at the point where the blade touches the work surface of a paper cutting machine. Upon each cut, the blade contacts the elastic protective strip rather than the work surface. Since the elastic protective strip is made of a deformable, relatively soft material as compared to the work surface, damage to the blade is lessened. However, requiring a groove in the work surface is problematic for passage of a material over the work surface. In particular, the material may catch upon or be misguided by the groove of the work surface, causing improper placement of the material for subsequent cuts. Moreover, as the elastic protective strip slightly settles or adjusts position within the groove, the material to be cut may sink into the groove, causing a slight variation between the length of a piece of material cut with a fresh elastic protective strip and the length of a piece of material cut on a relatively older elastic protective strip. Furthermore, the elastic protective strips of U.S. Pat. No. 5,121,664 are specifically designed for use with a drop blade cutting system and are unrelated to ultrasonic cutting.

Due to the above-described problems associated with typical cutting systems and the inadequacies of proposed solutions to such problems, a need exists for a cutting system that provides blade and working surface protection, particularly for use with ultrasonic blades. A further need exists for a blade and working surface protection device that can easily be integrated into the cutting system and cutting method without adding additionally cumbersome or time-consuming steps.

### SUMMARY OF THE INVENTION

One aspect of the present invention relates to an ultrasonic cutting system. The ultrasonic cutting system includes an ultrasonic cutting device, a base plate, and a protective device. The ultrasonic cutting device is configured to cut a material and includes a cutting blade. The base plate is configured to support a material for interaction with the cutting blade. The protective device includes a protective sheet routed over the base plate. During use, the material is routed over the protective sheet prior to interaction with the cutting blade, and the protective sheet is adapted to decrease contact between the cutting blade and the base plate.

Another aspect of the present invention relates to an ultrasonic cutting system. The ultrasonic cutting system includes an ultrasonic cutting device, a base plate, a protective device, and a controller. The ultrasonic cutting device is adapted to cut a material and includes a cutting blade. The base plate is adapted to support a material for interaction with the cutting blade. The protective device includes a protective sheet routed over the base plate. The protective sheet is configured to decrease contact between the cutting blade and the base plate. The controller is electrically coupled to the ultrasonic cutting device and the protective device. The controller is adapted to prompt performance of a cutting sequence by the ultrasonic cutting device.

Yet another aspect of the present invention provides an ultrasonic cutting method. The ultrasonic cutting method includes providing an ultrasonic cutting device including a cutting blade, providing a base plate to support the material for interaction with the cutting blade, routing a protective sheet over the base plate, routing the material over the protective sheet, and cutting the material via interaction with the cutting blade. The ultrasonic cutting device is adapted to cut the material. The protective sheet is adapted to decrease contact between the cutting blade and the base plate during the step of cutting the material.

### BRIEF DESCRIPTION OF THE DRAWINGS

FIG. 1 is a perspective view of one embodiment of an ultrasonic cutting system with a protective sheet in accordance with the present invention;

FIG. 2 is a top view of the ultrasonic cutting system of FIG. 1;

FIG. 3 is a front view of the ultrasonic cutting system of FIG. 1;

FIG. 4 is a side view of the ultrasonic cutting system of FIG. 1 in a resting and a cutting position;

FIG. 5A is a cross-sectional view of one embodiment of a portion of the ultrasonic cutting system of FIG. 3 along the line X-X prior to cutting a material;

FIG. 5B is a cross-sectional view of one embodiment of a portion of the ultrasonic cutting system of FIG. 3 along the line, X-X after one pass of an ultrasonic cutting device over the material;

FIG. 5C is a cross-sectional view of one embodiment of a portion of the ultrasonic cutting system of FIG. 3 along the line X-X after two passes of the ultrasonic cutting device over the material.

### DESCRIPTION OF THE PREFERRED EMBODIMENTS

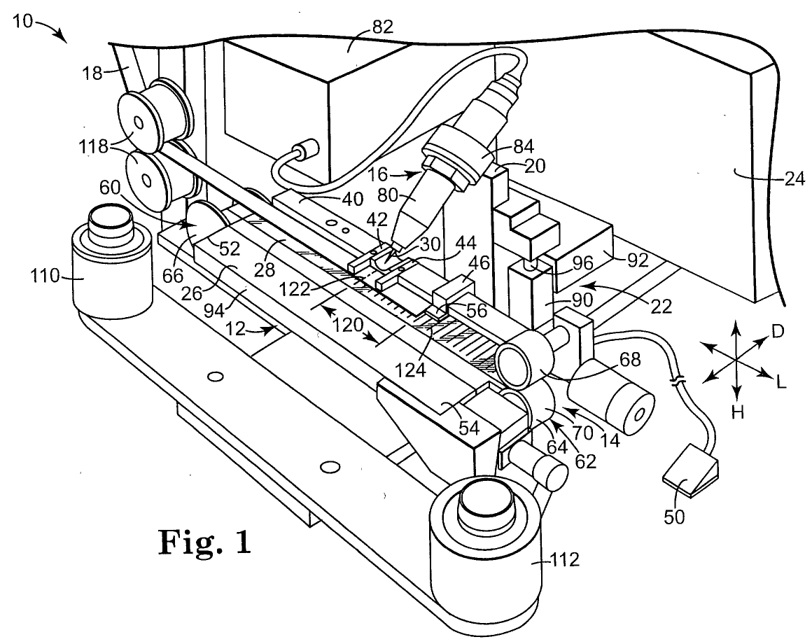

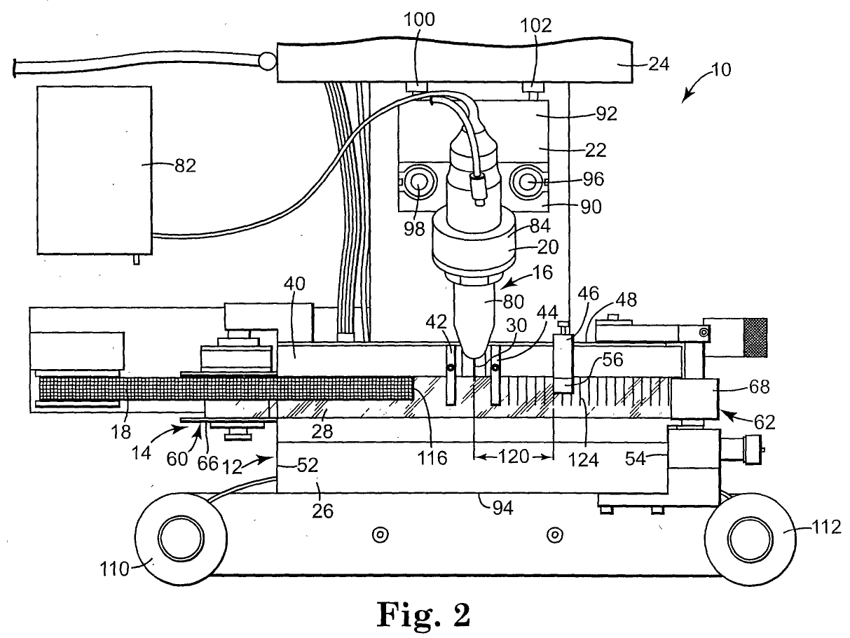

The present invention relates an ultrasonic cutting system including a protective sheet to prolong the life of a cutting blade. To this end, an exemplary ultrasonic cutting system 10 is primarily illustrated in FIG. 1, with further reference to FIGS. 2-4. Generally speaking, the ultrasonic cutting system 10 includes a base plate-assembly 12, a protective device 14, an ultrasonic cutting device 16 adapted to cut a material 18, a jig 20, a jig control mechanism 22, and a controller 24 (shown generally in the figures). The base plate assembly 12 includes a base plate 26, and the protective device 14 includes a protective sheet 28. The protective sheet 28 is routed over the base plate 26. During use, the material 18 is routed over the so-positioned protective sheet 28. The ultrasonic cutting device includes a cutting blade 30 adapted to cut the material 18. As such, the ultrasonic cutting device 16, and consequently the cutting blade 30, is positioned over the base plate 26 to periodically cut the material 18 and partially cut the protective sheet 28 without contacting the base plate 26 below. The jig 20 supports the ultrasonic cutting device 16 with respect to the base plate assembly 12. The jig control mechanism 22 is rigidly connected to the jig 20 and is adapted to mechanically adjust the position the jig 20 with respect to the base plate assembly 12. The controller 24 is adapted to prompt and control interaction between and within the aforementioned components.

In addition to the base plate 26, the base plate assembly 12 preferably includes a back rail 40, a first clamp 42, a second clamp 44, and a stop 46. The base plate 26 provides a smooth planar surface to support the protective sheet 28 and the material 18 as they pass over the base plate assembly 12. Preferably, the back rail 40 is secured to the base plate 26 near a back edge 48 (FIG. 2) of the base plate 26. More preferably, the back rail 40 is coupled to the base plate 26 at the back edge 48. In one embodiment, the back rail 40 extends along the entire length of the base plate 26, where length refers to the dimension extending perpendicular to the cutting bade orientation and indicated by direction arrow L in FIG. 1. Notably, as used throughout the specification, directional terminology, such as “length,” “height,” “depth,” “upward,” “downward,” “forward,” “backward,” “distal,” “proximate,” etc., is used for purposes of illustration only and is in no way limiting.

The first clamp 42 and the second clamp 44 are mounted upon the back rail 40 and protrude over the exposed base plate 26. Both the first clamp 42 and the second clamp 44 are adapted to releasably provide pressure upon the base plate 26, i.e. to transition between a released state and a clamped state with respect to base plate 26. In one preferred embodiment, a foot pedal 50 is coupled to the base plate assembly 12, wherein upon depression of the foot pedal 50, the first and second clamps 42, 44 transition from the released state to the clamped state. Preferably, the foot pedal 50 is pneumatically connected to the first and second clamps 42, 44 and functions via compressed air or hydraulic fluid. However, any user control known in the art to be capable of prompting the first and second clamps 42, 44 to transition between a released state and a clamped state is also acceptable.

The base plate 26 defines a proximal end 52 and a distal end 54. The stop 46 is movably coupled with the back rail 40, preferably, positioned near the distal end 54 of the base plate 26. More preferably, the stop 46 is distally located in comparison to the first and second clamps 42, 44. The stop 46 is supported by the back rail 40 and includes a stop leg 56, which extends from the back rail 40 onto the base plate 26. The stop 46 is movably coupled with the back rail 40 such that the stop 46 is adapted to slide along the back rail 40. Since the position of the stop 46 along the back rail 40 is slidably adjustable, the stop 46 can be located at a predetermined location upon the back rail 40 dependent upon the specifications of a cutting sequence to be performed, as will be further described below.

In addition to the protective sheet 28, the protective device 14 includes a source 60 and a collector 62. Initially, the source 60 contains the protective sheet 28, which initially has a free end (not shown). The free end is routed from the source 60 to the collector 62. Preferably, the collector 62 includes an advancement mechanism or drive 64 adapted to intermittently actuate the protective sheet 28 from the source 60 to the collector 62. During use of the protective device 14, the protective sheet 28 is intermittently translated or pulled from the source 60 to the collector 62 as dictated by the advancement mechanism 64. The advancement mechanism 64 may be any device or method known in the art to drive the protective sheet 28 from the source 60 to the collector 62, such as a drive wheel or a conveyor, and remain within the scope of the present invention.

The protective sheet 28 is preferably made of a material exhibiting thermoset or thermoset-like properties such that any heat generated by friction during a cutting process will not affect the hardened properties of the protective sheet 28. Preferably, the protective sheet 28 also has a relatively small coefficient of friction, such that the material 18 can move or slide upon the protective sheet 28. More preferably, the protective sheet 28 will be made from a polymeric material, such as an acetate material, although other materials are equally acceptable. In one preferred embodiment, the protective sheet 28 has a thickness in the range of 0.001-0.010 inch, most preferably 0.005 inch.

In one preferred embodiment incorporating a thin film as the protective sheet 28, the source 60 includes a supply reel 66 and the collector 62 includes opposing pinch rollers 68, 70. The protective sheet 28 is initially wound upon the supply reel 66, and the free or leading end (not shown) of the protective sheet 28 is routed between the pinch rollers 68, 70. In one embodiment, the advancement mechanism 64 drives or rotates the pinch roller 64 in a desired fashion, causing the sheet 28 to be pulled from the supply reel 66 (to the right relative to the orientation of FIG. 1). This, in turn, translates the protective sheet 28 across the baseplate 26 as described below. The excess or used (i.e., partially cut) segment of the protective sheet 28 extends away from the pinch rollers 68, 70 for subsequent removal by the user (it being understood that the excess material is not shown in the Figures for ease of illustration). Alternatively, the excess protective sheet 28 material can be wound about one of the pinch rollers 68, 70. Upon complete advancement of the protective sheet 28 from the supply reel 66, the used protective sheet 28 is removed and discarded. A new protective sheet 28/supply reel 66 is mounted and similarly routed to the take-up reel 68 to continue the process.

In one embodiment, the protective sheet 28 is routed over the base plate 26 of the base plate assembly 12. As such, source 60 is preferably located near the proximal end 52 of the base plate 26 and the collector 62 is preferably located near the distal end 54 of the base plate 26. In this manner, the protective sheet 28 is routed from the source 60, over the length of the base plate 26, and to the collector 62. Notably, the source 60 and the collector 62 are positioned at an appropriate height with respect to the base plate 26 such that the protective sheet 28 lies directly upon the base plate 26, but below the first and second clamps 42, 44 and the stop leg 56. In one embodiment, the protective sheet 28 is further positioned to run along or be guided by the back rail 40.

In addition to the cutting blade 30, one embodiment of the ultrasonic cutting device 16 includes a housing 80, a vibration mechanism (not shown), and a power source 82. The cutting blade 30 is secured to and protrudes from the housing 80 and is electrically connected to the vibration mechanism. The cutting blade 30 is any sharp metal blade as is known in the art. The vibration mechanism is contained by the housing 80 and may be any device known in the art capable of imparting an ultrasonic vibration to the cutting blade 30 to activate the cutting blade 30. As such, the vibration mechanism is electrically connected to the power source 82. The power source 82 may be an alternating current electrical source, a direct current electrical source, or any other power source as is known in the art. Upon user or computer initiation, the power source 82 supplies power to and activates the vibration mechanism. Activation of the vibration mechanism generates ultrasonic vibration and imparts that vibration to the cutting blade 30 to ready the cutting blade 30 for cutting. One exemplary embodiment of the ultrasonic cutting device 16 is available under the tradename “US-16CB Sonic Cutter” from NSK Nakanishi Inc. of Tochigi-Ken, Japan.

Upon final assembly, the ultrasonic cutting device 16 is located above the base plate 26 and the protective sheet 28. In particular, the ultrasonic cutting device 16 is positioned with respect to the length of the base plate 26 such that the cutting blade 30 is positioned between the first clamp 42 and the second clamp 44 of the base plate assembly 12.

The jig 20 is located to a lateral side (with respect to the orientation of FIGS. 1-4) of the base plate 12 and is adapted to support and mechanically maintain the position of the ultrasonic cutting device 16 with respect to the base plate assembly 12. The jig 20 preferably includes a clamp ring or collar 84. The collar 84 is configured to secure the housing 80 of the ultrasonic cutting device 16 to the jig 20. In one preferred embodiment, the collar 84 is adapted to at least partially circumscribe the housing 80, such that the housing 80 is secured or clasped within the collar 84. However, other methods of connection between the housing 80 and the jig 20 are equally acceptable.

The jig control mechanism 22 is rigidly coupled to the jig 20 and is adapted to mechanically adjust the position of the jig 20 with respect to the base plate assembly 12 in at least two dimensions. As such, the jig control mechanism 22 includes a height control 90 and a depth or lateral position control 92. For purposes of illustration, depth or lateral position refers to the lateral dimension extending perpendicular to the length of the base plate 26 and is indicated by bi-dimensional arrow D (FIG. 1). Furthermore, within the depth dimension, “forward” (relative to the position of FIG. 1) refers to movement of the jig 20 and thereby the ultrasonic cutting device 16 toward a leading edge 94 of the base plate 26, and “backward” refers to movement of the ultrasonic cutting device 16 away from the leading edge 94 of the base plate 26. The lateral position control 92, thereby, allows the jig 20 and the ultrasonic cutting device 16to be laterally moved forward and backward with respect to the leading edge 94 of the base plate 26. The height control 90 allows the jig 20 to be vertically moved up and down (relative to the position of FIG. 1) with respect to the base plate 26 in the direction indication by bi-dimensional arrow H in FIG. 1.

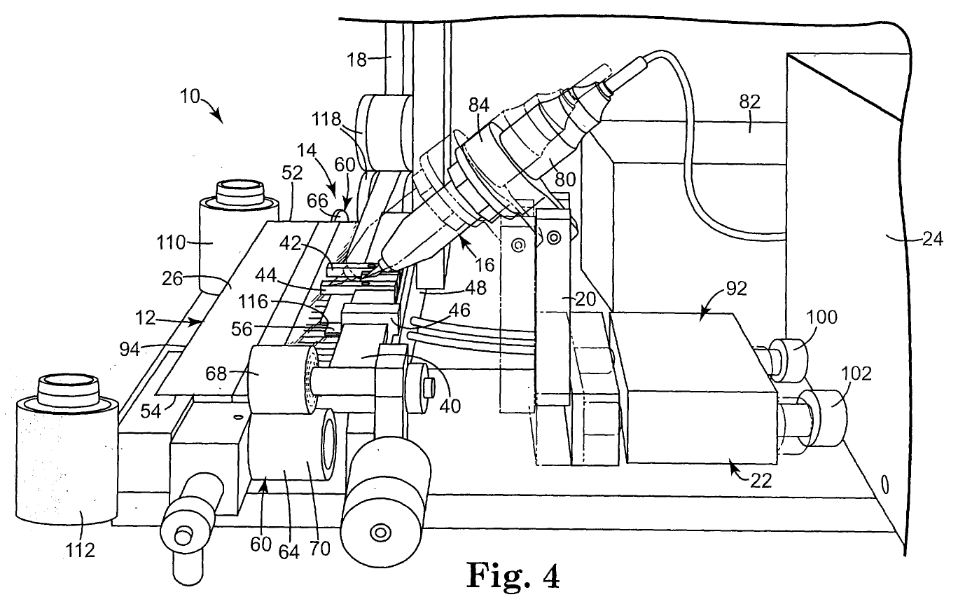

In one preferred embodiment, the height control 90 includes a first height control piston 96 and a second height control piston 98, as best shown in FIG. 1 and FIG. 2. Similarly, in one preferred embodiment, the lateral position control 92 includes a first lateral position control piston 100 and a second lateral position control piston 102, as best shown in FIG. 4. During use, the first and second height control pistons 96, 98 and the first and second lateral position control pistons 100, 102 allow the jig control mechanism 22 to transition the jig 20, and consequently the ultrasonic cutting device 16, laterally and vertically as dictated by a user or a computer system. The height control 90 and the lateral position control 92 may function via hydraulics, compressed air, or other method known in the art. Notably, other methods of height and depth adjustment of the jig 20 as are known in the art may be used and remain within the scope of the present invention.

The ultrasonic cutting device 16, the jig control mechanism 22, and advancement mechanism of the protective device. 14 are electrically or pneumatically connected to the controller 24. The controller 24 is adapted to oversee and initiate action by each of the ultrasonic cutting device 16, the jig control mechanism 22, and the protective device 14. More particularly, the controller 24 is adapted to initiate the power source 82, which activates the vibration mechanism (not shown) thereby imparting ultrasonic vibration to the cutting blade 30 of the ultrasonic device 16. In addition, the controller 24 is preferably adapted to dictate when the advancement mechanism 64 of the protective device 14 is activated. Furthermore, the controller 24 is also adapted to interact with the jig control mechanism 22 to dictate the positioning of the height control 90 and the lateral position control 92. In one embodiment, the user (not shown) inputs predetermined positions of the height control 90 and the lateral position control 92 into the controller 24 prior to use of the ultrasonic cutting system 10 in the cutting process. The controller 24 preferably is adapted to store at least two preset height positions and at least two preset lateral positions of the jig control mechanism 22 within a memory (not shown) of the controller 24.

The controller 24 may be any computer processing unit or other mechanism known in the art to be capable of interacting with the ultrasonic cutting device 16, the jig control mechanism 22, and the protective device 14, as described above. In one preferred embodiment, the controller 24 is connected to a first hand control 110 and a second hand control 112. The first hand control 110 and the second hand control 112 provide a user interface with the controller 24. Upon user interaction with the first and second hand controls 110, 112, the controller 24 is adapted to prompt the ultrasonic cutting device 16, the jig control mechanism 22 and the protective device 14 to perform a number of steps comprising a cutting sequence including protective sheet advancement, as further described below.

In one embodiment, the first hand control 110 is a first button and the second hand control 112 is a second button, wherein simultaneous depression of the first button and the second button activates the controller 24 to prompt the components of the ultrasonic cutting system 10 to perform the cutting sequence. Notably, although a single hand control or foot control is sufficient to provide the user interface with the controller 24, two hand controls are preferred to promote safety by ensuring that both hands of the operator are placed out of the path of the cutting blade 30 during the cutting process.

The material 18 to be cut by the ultrasonic cutting device 10 is a sheet material and may have a single layer or a plurality of separate layers or may be a tube material. Although the ultrasonic cutting system 10 is adapted to cut various types of materials, ultrasonic cutting device 16 is particularly effective in cutting woven, high tenacity polymeric material. In particular, the ultrasonic vibration generation by the mechanism (not shown) and imparted to the cutting blade 30 produces friction between the cutting blade 30 and a material to be cut thereby producing heat. The cutting blade 30 in conjunction with the generated heat more easily cuts high tenacity fabrics. Further, in the case of woven polymeric materials, the generated heat also serves to seal the fabric edge from unraveling, thereby producing a cleaner material cut. In one preferred embodiment, the material 18 is a high molecular weight polyethylene used as a weave material to form a constraining jacked for a prosthetic disc nucleus as disclosed in U.S. Pat. No. 6,022,376, the teachings of which are incorporated herein by reference.

Prior to performance of a cutting sequence by the ultrasonic cutting system 10, the user (not shown) inputs the two preset height control positions and the two preset lateral control positions into the memory (not shown) of the controller 24. In particular, the preset positions represent a resting height and a resting lateral position as well as a cutting height and a cutting lateral position. The resting height, the resting lateral position, the cutting height, and the cutting lateral position are each determined based upon the characteristics of the material 18 and the type of cut to be performed as will become apparent to those of ordinary skill in the art.

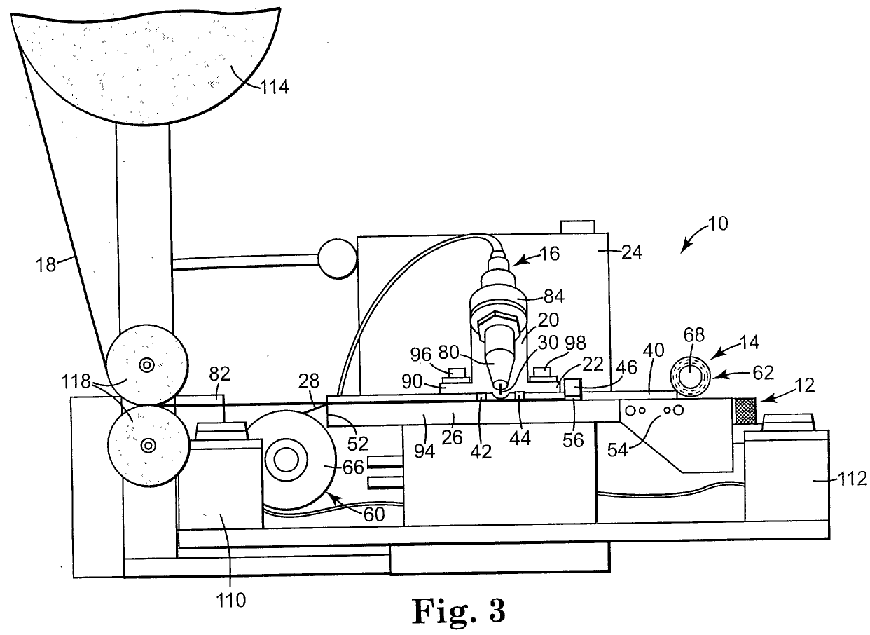

The material 18 is initially stored on or in a material source 114 (FIG. 3) and includes a free end 116. In one embodiment, the material source 114 is a material supply reel, and the material 18 is initially wound about the material source 114. During use of the ultrasonic cutting device 10, a user (not shown) routes the free end 116 of the material 18 from the material source 114 through a plurality of guide wheels 118 and across the base plate 26 of the base plate assembly 12. The plurality of guide wheels 118 are positioned with respect to the base plate 26 such that the material 18 extends substantially horizontally from the plurality of guide wheels 118 along the base plate 26. More particularly, the material 18 extends from the plurality of guide wheels 118 onto the protective sheet 28 that extends over the base plate 26.

In a preferred embodiment, the user extends the material 18 along the back rail 40 and over the protective sheet 28 to the stop 46, more particularly the stop leg 56, of the back rail 40. More preferably, the material 18 is pulled under the first and second clamps 42 and 44 to the stop leg 56. As previously described, the position of the stop 46 along the back rail 40 is adjustable. As such, the position of the stop 46 is positioned a predetermined distance 120 away from the cutting blade 30 before extension of the material 18 for cutting. Notably, the predetermined distance 120 equals a desired length of the piece of the material 18 to be cut. Upon extension of the material 18 to the pre-positioned stop 46, the first and second clamps 42, 44 are engaged, preferably by depression of the foot pedal 50 by a user. The engaged first and second clamps 42, 44 apply pressure to the material 18 and the base plate 26, thereby tightly holding the material 18 in place above the protective sheet 28 and on the base plate 26. More preferably, the material 18 is held slightly taut upon engagement of the first and second clamps 42, 44 to impart a slight tension on the material 18 for cutting.

Upon positioning and clamping of the material 18 along and to the base plate 26, the cutting sequence is activated by the user (not shown), preferably via the hand controls 110, 112 connected to the controller 24. Upon activation, the controller 24 prompts the jig control mechanism 22 to transition the lateral position control 92 from the preset resting lateral position to the preset cutting lateral position and the height position control 90 downward (with respect to the orientation of the figures) from the preset resting height to the preset cutting height. Notably, movement of the jig control mechanism 22 effectuates similar movement in the jig 20 and the ultrasonic cutting device 16 including the cutting blade 30.

Upon transition to the cutting lateral position and the cutting height, the controller 24 activates the power source 82, thereby imparting power to the vibration mechanism (not shown) of the ultrasonic cutting device 16. Consequently, the powered vibration mechanism generates and imparts ultrasonic vibration to the cutting blade 30. During vibration of the cutting blade 30, the jig control mechanism 22 returns the jig 20 to the resting lateral position as dictated by the controller 24. Movement of the jig 20 to the resting lateral position draws the cutting blade 30 through the material 18. As the cutting blade 30 is drawn through the material 18, the material 18 is cut resulting in a material cut 122. As previously described, the protective sheet 28 has a relatively low coefficient of friction and, thereby, allows the material 18 to move upon the protective sheet 28. As such, the vibration introduced to the material 18 via the cutting blade 30 is focused on the material 18 and not the protective sheet 28. The focused vibration similarly focuses the friction and heat generated by the vibration to the material 18 to facilitate rapid cutting of the material 18 and to form a heat seal on the raw edge of the material 18 to prevent fraying (where the material 18 is of a type conducive to heat sealing). Following transition to the resting lateral position, the vibration mechanism is deactivated and the jig control mechanism 22 returns to the resting height per instructions from the controller 24 to complete a cutting pass.

The material cut 122 may penetrate the full thickness of the material 18, and may create a partial cut 124 in the protective sheet 28. However, the cutting sequence can be adapted such that the single cutting pass of the cutting blade 30 over the material 18 only imparts a partial cut upon the material 18. Therefore, depending upon the characteristics of the material 18, the cutting sequence may include a second, third, etc. cutting pass to effectuate a complete cut of the material 18. For example, to fully cut the material 18 when it has a plurality of layers and/or is made of a high tenacity fabric, the cutting sequence will include more cutting passes than if the material 18 has a single layer or is made of a relatively low strength fabric. More particularly, if the material 18 has two layers (such as a flattened tube), two cutting passes are preferably performed. Further, where more than two layers are presented, a corresponding number of cutting passes are preferably performed (e.g., with four layers, four cutting passes are executed). However, multiple-layers or a tube may be fully cut by a single cutting pass or more than one cutting pass per layer. Furthermore, the resting height, the cutting height, the resting lateral position, and the cutting lateral position are all determined based upon the width and thickness of both the material 18 and the protective sheet 28, such that upon completion of the desired number of cutting passes, the material 18 is fully cut and the protective sheet 28 is partially cut, thereby decreasing contact between the cutting blade 30 and the base plate 26. Moreover, the execution speed of each of the cutting passes is also determined based upon the characteristics of the material 18 for optimum cutting.

In one embodiment of the ultrasonic cutting system 10, the protective sheet 28 advances slightly between each cutting pass. In another preferred embodiment, the protective sheet 28 advances slightly after the material 18 is fully penetrated and the protective sheet 28 is partially cut. Advancement of the protective sheet 28 after the final cutting pass completes the cutting sequence. Upon execution of a number of cutting sequences, a plurality of the partial cuts 124 (as illustrated in FIGS. 1,2, and 4) will have been created on the protective sheet 28. Notably, the selected cutting height should ensure that the base plate 26 will not be contacted by the cutting blade 30.

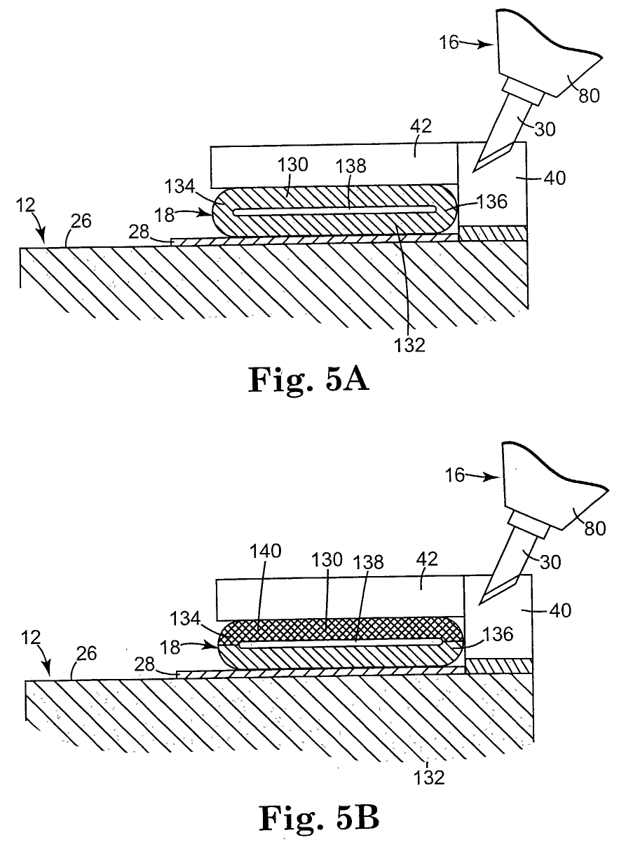

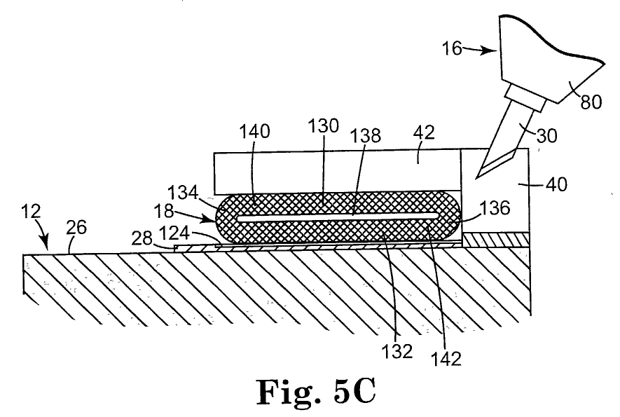

One exemplary embodiment of a cutting sequence is illustrated in FIGS. 5A, 5B, and 5C. FIG. 5A illustrates a cross-section of one embodiment of a portion of the ultrasonic cutting system 10 prior to execution of the cutting sequence. The protective sheet 28 is routed over the base plate assembly 12, and the material 18 is routed over the protective sheet 28. The material 18, illustrated as a flattened tube for exemplary purposes only, is held in place by the engaged first clamp 42 and the engaged second clamp 44 (FIG. 3). The tube material 18, when tightly folded by the first and second clamps 42, 44, essentially defines a first layer 130 and a second layer 132. The first layer 130 and the second layer 132 are linked on each edge via a first end 134 and a second end 136. The material 18 is illustrated with a gap 138 between the first layer 130 and the second layer 132 for illustration purposes only. That is to say, the tube 18 will normally lie flat. The ultrasonic cutting device 16 is illustrated at the resting height and the resting lateral position.

Upon user interaction with the user control 24 (FIG. 3), a cutting sequence including a first cutting pass and a second cutting pass is performed. The ultrasonic cutting device 16 is moved to a first cutting height and a first cutting lateral position. Preferably, the first cutting lateral position extends the ultrasonic cutting device 16 over the material 18 such that the cutting blade 30 is positioned just forward of the first end 134. Ultrasonic vibration is imparted to the cutting blade 30, and the jig control mechanism 22 returns the ultrasonic device 16 to the resting lateral position, consequently drawing the cutting blade 30 through at least the first layer 130 and a portion of the first end 134 and the second end 136 of the material 18. The ultrasonic cutting device 16 is returned to the resting height to complete the first cutting pass. In a preferred embodiment where the material 18 is a high tenacity woven material, operating the ultrasonic cutting device 16 to cut only the first layer 130 (i.e., not cut the second layer 132) has surprisingly been found to produce optimal cuts. In particular, it has surprisingly been found that the second layer 134 (or any additional layers below the layer being cut) dissipates the ultrasonic energy, so that only one layer should be cut with each cutting pass.

FIG. 5B illustrates the portion of the ultrasonic cutting system of FIG. 5A after completion of the first cutting pass. Drawing the cutting blade 30 through the material 18 produces a first material cut 140 as indicated by the double cross-hatching. In one embodiment, the first material cut 140 fully penetrates the first layer 130 but does not fully penetrate the second layer 132. As such, a second cutting pass, similar to the first cutting pass, is performed to fully cut the material 18. The ultrasonic cutting device 16, and in particular the blade 30, is located at the same position of the first cut and at a height for cutting the second layer 132. Ultrasonic vibration is imparted to the cutting blade 30, and the jig control mechanism 22 returns the ultrasonic cutting device 16 to the resting lateral position. Returning the ultrasonic cutting device 16 to the resting lateral position draws the cutting blade 30 the second layer 132 of the material 18. In one embodiment, returning the ultrasonic cutting device 16 to the resting lateral position during the second cutting pass also draws the cutting blade 30 across the protective sheet 28. The vibration mechanism is deactivated, the jig control mechanism 22 returns the ultrasonic cutting device 16 to the resting height, and the protective sheet 28 is automatically slightly advanced toward the collector 62 to complete the second cutting pass. Notably, depending upon the characteristics of the material 18, the second cutting height and the second cutting lateral position may or may not be equal to the first cutting height and the first cutting lateral position. Furthermore, the protective sheet 28 is advanced after completion of the second cutting pass to present the cutting blade 30 a fresh surface of the protective sheet 28 for subsequent cutting sequences. In other words, the cutting blade 30 preferably is never passed over or cuts the same area of the protective sheet 28 twice. In an alternative embodiment, the protective sheet 28 is slightly advanced after each of the first cutting pass and the second cutting pass.

FIG. 5C illustrates the embodiment of the portion of the ultrasonic cutting system 10 of FIG. 5A after completion of the cutting sequence. Drawing the ultrasonic cutting blade 30 through the first and second layers 130, 132 of the material 18 and across the protective sheet 28 produces a second material cut 142 in the material 18 and the partial cut 124 in the protective sheet 28. The second material cut 142 fully penetrates the first and second layers 130, 132, the first end 134, and the second end 136 of the material 18, thereby separating the piece of material 144 (FIG. 1) from the remaining material 18. The partial cut 124 only partially penetrates the protective sheet 28, such that the cutting blade 30 does not contact the base plate assembly 12 and that the protective sheet 28 remains substantially intact.

The ultrasonic cutting system of the present invention provides a marked improvement over previous designs. The protective device included in the ultrasonic cutting system provides for blade and base plate protection to prolong the longevity of the cutting process without requiring cumbersome equipment or timely adjustments to the system upon each cut. Further, an ultrasonic blade provides for a superior material cut in certain types of fabric and materials.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. The application is intended to cover any adaptations or variations of the preferred embodiments discussed herein. Therefore, it is manifestly intended that this invention be limited only by the claims and their equivalents thereof.

What is claimed is:

1. An ultrasonic cutting system comprising:
an ultrasonic cutting device configured to cut a material, the ultrasonic cutting device including a cutting blade;
a base plate configured to support a material during interaction with the cutting blade; and
a protective device including a protective sheet routed over the base plate, wherein during use the material is routed over the protective sheet prior to interaction with the cutting blade, the protective sheet being configured to decrease contact between the cutting blade and the base plate during use.

2. The ultrasonic cutting system of claim 1, further comprising:
a first clamp connected to the base plate, the first clamp configured to selectively retain the material against the base plate; and
a second clamp spaced from the first clamp, the second clamp being connected to the base plate and configured to selectively retain the material against the base plate;
wherein the ultrasonic cutting blade is positioned between the first clamp and the second clamp.

3. The ultrasonic cutting system of claim 1, wherein the protective device further includes:
a source initially housing the protective sheet, and
a collector spaced from the source,
wherein the protective sheet is routed from the source, over the base plate, and to the collector.

4. The ultrasonic cutting system of claim 3, wherein the protective device further includes:
an advancement mechanism configured to effectuate movement of a cut portion of the protective sheet toward the collector.

5. The ultrasonic cutting system of claim 3, wherein the source is a supply reel and the protective sheet is initially wound about the supply reel.

6. The ultrasonic cutting system of claim 1, wherein the protective sheet exhibits thermoset properties.

7. The ultrasonic cutting system of claim 1, wherein the protective sheet is an acetate-based film.

8. The ultrasonic cutting system of claim 1, wherein the protective sheet is configured to focus ultrasonic energy to the material.

9. An ultrasonic cutting system comprising:
an ultrasonic cutting device configured to cut a material, the ultrasonic cutting device including a cutting blade;
a base plate configured to support a material during interaction with the cutting blade;
a protective device including a protective sheet routed over the base plate, the protective sheet configured to decrease contact between the cutting blade and the base plate; and
a controller electrically coupled to the ultrasonic cutting device and the protective device, the controller configured to prompt performance of a cutting sequence by the ultrasonic cutting device.

10. The ultrasonic cutting system of claim 9, wherein the controller is further configured to prompt advancement of the protective sheet from a source, across the base plate, and to a collector.

11. The ultrasonic cutting system of claim 9, wherein the controller is connected to least one hand control, the at least one hand control adapted to provide a user interface with the controller.

12. The ultrasonic cutting system of claim 11, wherein the at least one hand control includes:
a first hand control, and
a second hand control spaced from the first hand control,
wherein simultaneous depression of the first hand control and the second hand control activates the controller to prompt performance of the cutting sequence by the ultrasonic cutting device.

13. The ultrasonic cutting system of claim 9, wherein the protective sheet is a thermoset film.

14. The ultrasonic cutting system of claim 9, wherein the controller is adapted to perform a plurality of cutting passes corresponding to a number of layers of the material being cut

15. An ultrasonic cutting method comprising:
providing an ultrasonic cutting device configured to cut a material, the ultrasonic cutting device including a cutting blade;
providing a base plate to support the material during interaction with the cutting blade;
routing a protective sheet over the base plate;
routing the material over the protective sheet; and
cutting the material via interaction with the cutting blade;
wherein the protective sheet is configured to decrease contact between the cutting blade and the base plate during the step of cutting the material.

16. The ultrasonic cutting method of claim 1, further comprising:
cutting the material with the cutting blade of the ultrasonic cutting device a second time;
wherein the protective sheet decreases wear on the cutting blade during both steps of cutting the material.

17. The ultrasonic cutting method of claim 15, wherein cutting the material includes:
drawing the cutting blade through at least a portion of the material.

18. The ultrasonic cutting method of claim 15, wherein the step of cutting the material includes:
partially cutting the protective sheet with the cutting blade.

19. The ultrasonic cutting method of claim 15, wherein the method further includes:
clamping the material and the protective sheet to the base plate prior to the step of cutting the material.

20. The ultrasonic cutting method of claim 15, wherein the material is a high tenacity material.

21. The ultrasonic cutting method of claim 15, wherein the material is a woven material.

22. The ultrasonic cutting method of claim 15, wherein the material has two layers, and further wherein the step of cutting includes performing a first cutting pass to cut the first layer and a second cutting pass to cut the second layer.

23. The ultrasonic cutting method of claim 22, wherein the material is a flattened tube.

24. The ultrasonic cutting method of claim 15, wherein the protective sheet focuses an ultrasonic vibration from the ultrasonic cutting device on the material during the step of cutting the material.

25. The ultrasonic cutting method of claim 15, further comprising:
advancing the protective sheet across the working surface after the step of cutting the material.
